(19) United States
(12) Patent Application Publication
(10) Pub. No.: US 2011/0161875 A1
(43) Pub. Date: Jun. 30, 2011

(54) METHOD AND APPARATUS FOR DECLUTTERING A MAPPING DISPLAY

(75) Inventor: Mikko Kankainen, Helsinki (FI)

(73) Assignee: Nokia Corporation, Espoo (FI)

(21) Appl. No.: 12/648,822

(22) Filed: Dec. 29, 2009

(51) Int. Cl. G06F 3/048

(52) U.S. Cl. 715/810

(57) ABSTRACT

An approach is provided for decluttering a mapping display. A decluttering manager causes, at least in part, rendering of a plurality of points of interest on a mapping display of a user device based on location information associated with each of the points of interest. The decluttering manager receives an input, from the device, for selecting a group of the points of interest on the mapping display and captures an image of the mapping display based on the input. The decluttering manager then caused, at least in part, display of the selected group of the points of interest as an overlay on the captured image.

### BACKGROUND

Service providers (e.g., wireless, cellular, etc.) and device manufacturers are continually challenged to deliver value and convenience to consumers by, for example, providing compelling network services. In particular, these services can include location and navigation services on a device. However, often user interfaces associated with these services do not or cannot provide adequate or complete navigational information on a screen of a user's device, particularly when the device is a mobile device with a limited display area. In other cases, the user interfaces may be presented in a way that limits the usability of the presented navigational information for a user. For example, users may not be able to understand the significance of objects displayed on the device because the interface is cluttered with too many objects (e.g., points of interest). Thus, users are unable to fully utilize the available functions of the location or navigation services because the interface may be difficult or cumbersome. Accordingly, service providers and device manufacturers face significant technical challenges in providing user interfaces that present navigational information in ways that can be more easily and quickly understood by the user.

### SOME EXAMPLE EMBODIMENTS

Therefore, there is a need for an approach for efficiently and effectively decluttering a mapping display.

According to one embodiment, a method comprises causing, at least in part, rendering of a plurality of points of interest on a mapping display of a user device based on location information associated with each of the points of interest. The method also comprises receiving an input, from the device, for selecting a group of the points of interest on the mapping display. The method further comprises causing, at least in part, capture of an image of the mapping display based on the input. The method further comprises causing, at least in part, display of the selected group of the points of interest as an overlay on the captured image. The display of the selected group distinctly renders each of points of interest in the selected group.

According to another embodiment, an apparatus comprising at least one processor, and at least one memory including computer program code, the at least one memory and the computer program code configured to, with the at least one processor, cause, at least in part, the apparatus to render a plurality of points of interest on a mapping display of a user device based on location information associated with each of the points of interest. The apparatus is also caused to receive an input, from the device, for selecting a group of the points of interest on the mapping display. The apparatus is further caused to capture an image of the mapping display based on the input. The apparatus is additionally caused to display the selected group of the points of interest as an overlay on the captured image. The display of the selected group distinctly renders each of points of interest in the selected group.

According to another embodiment, a computer-readable storage medium carrying one or more sequences of one or more instructions which, when executed by one or more processors, cause, at least in part, an apparatus to render a plurality of points of interest on a mapping display of a user device based on location information associated with each of the points of interest. The apparatus is also caused to receive an input, from the device, for selecting a group of the points of interest on the mapping display. The apparatus is further caused to capture an image of the mapping display based on the input. The apparatus is additionally caused to display the selected group of the points of interest as an overlay on the captured image. The display of the selected group distinctly renders each of points of interest in the selected group.

According to another embodiment, an apparatus comprises means for causing, at least in part, rendering of a plurality of points of interest on a mapping display of a user device based on location information associated with each of the points of interest. The apparatus also comprises means for receiving an input, from the device, for selecting a group of the points of interest on the mapping display. The apparatus further comprises means for causing, at least in part, capture of an image of the mapping display based on the input. The apparatus additionally comprises means for causing, at least in part, display of the selected group of the points of interest as an overlay on the captured image. The display of the selected group distinctly renders each of points of interest in the selected group.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of decluttering a mapping display, according to one embodiment;

FIG. 2 is a diagram of the components of a decluttering manager, according to one embodiment;

FIG. 3 is a diagram of the components of a user equipment capable of decluttering a mapping display, according to one embodiment;

FIG. 4 is a flowchart of a process for decluttering a mapping display, according to one embodiment;

FIG. 5 is a flowchart of a process for rendering a decluttered mapping display on multiple screens, according to one embodiment;

FIG. 6 is a diagram of user interfaces utilized in the process of FIG. 4, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for decluttering a mapping display are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to a mapping display that is an augmented reality display, it is contemplated that the approach described herein may be used with any other mapping displays including, but not limited to, three-dimensional maps, two-dimensional maps, navigation maps, topographical maps, user location-tracking maps, and the like.

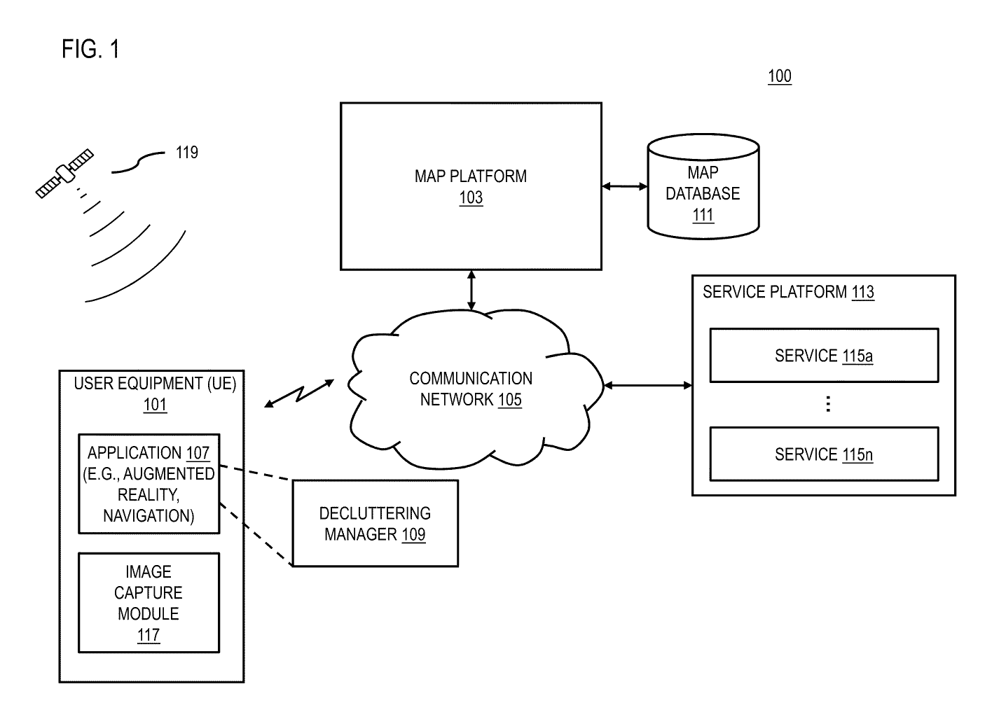

FIG. 1 is a diagram of a system capable of decluttering a mapping display, according to one embodiment. It is becoming increasingly popular for service providers and device manufacturers to bundle or make available navigation and mapping services on an array of user devices (e.g., mobile handsets, computers, navigation devices, etc.) Such devices may utilize location based technologies (e.g., Global Positioning System (GPS) receivers, cellular triangulation, assisted-GPS (A-GPS), etc.) to provide navigation and mapping information. One growing trend for these services is to move beyond two-dimensional (2D) maps and provide location services based on three-dimensional (3D) maps or representations of locations and/or routes of interest. For example, modern devices may utilize an augmented reality mode to superimpose graphics and text over video images showing buildings in front of the user. Moreover, certain devices may utilize 3D representations (e.g., rendered 3D models) of buildings and streets to provide navigational or mapping information. These devices may use separate graphical objects in place of or overlaid on actual images of buildings and streets to provide additional navigational information.

However, these conventional 3D-based interfaces can be rather cumbersome for displaying information on a user device. For example, in the case of a mobile device (e.g., a smartphone, mobile handset, etc.), the available display is generally limited and can quickly become cluttered when there are many elements (e.g., points of interest (POIs), navigation instructions, etc.) to display. This cluttered display makes it much more difficult for a user to quickly identify important navigational information. This quick identification is particularly crucial when the user is relying on real-time navigational instructions to reach a destination. By way of example, in an augmented reality application, multiple nearby POIs can cause clutter in the display, making it difficult (if not impossible) to see all POIs. In other words, when there is a high density of POIs in the mapping display, graphical representations (e.g., icons, labels, etc.) depicting the POIs can overlap and obscure one another.

To address this problem, a system 100 of FIG. 1 introduces the capability of selecting one or more POIs or groups of POIs on a cluttered mapping display (e.g., an augmented reality display with multiple nearby POIs), capturing an image of the mapping display, and then overlaying the selected POIs as a list or other format for distinctly rendering each POI. With this approach, the system 100 can distinctly render and declutter one or more of the POIs that are visible or present in a particular mapping display. For example, in an augmented reality display, the system 100 displays a live camera view of the surrounding location and supplements with the live image with rich content information (e.g., pictures, media, text labels, descriptions, etc.) relevant to each POI in a real time manner. The viewpoint for providing the augmented reality display is dependent on, for instance, where the user's device is pointed as determined by the device's location, directional heading, and tilt angle. Accordingly, as the user moves the device, the view in the augmented reality display and the displayed POIs change dynamically based on the movement. At any time, the user can select one or more of the POIs in the current display to initiate decluttering by tapping on a desired POI or group of POIs. In order to maintain reference to the viewpoint of the user device at the time of the decluttering request, the system 100 captures an image of the mapping display and then presents a list of the selected POIs overlaid on the captured image. In other words, the captured image is used as a background image on which the POI list is presented. In this way, the user device need not remain at the same viewpoint while viewing the decluttered mapping display. In certain embodiments, the system 100 can also declutter the mapping display by grouping the graphical representations (e.g., icons) of nearby POIs into one graphical representation (e.g., a group icon). The group icon can then be selected for decluttering which, in turn, will cause the POIs represented in the group icon to be expanded and displayed individually as an overlay on the captured image.

It is also contemplated that the system 100 can overlay all of the POIs (as opposed to just the selected POIs) in list form or other non-overlapping format. If there are more POIs than can fit on the screen at one time, the system 100 enables the user to scroll through the list or can present multiple screens of the list while maintaining the captured image as a background image for the display. By displaying the POIs in list form, the system 100 advantageously presents each POI distinctly (e.g., by not overlapping the graphical presentations of each POI) so that the user can review each POI more easily. Causing, at least part, rendering of the POIs as a list in a decluttered display is a means to achieve this advantage. Additionally, because the POIs are presented as an overlay on a captured view of the mapping display associated with the POIs, the user can still relate the POI information to a corresponding location depicted in the captured image even if the user device is moved so that the device's viewpoint changes. Causing, at least in part, capturing of an image of the mapping display and overlaying the rendering of the POIs on the display are means to achieve this advantage. In one embodiment, the system 100 can also determine information specifying the viewpoint for capturing the image (e.g., the location, directional heading, and tilt angle of the device at the time the image was captured) and store the information with the captured image (e.g., as metadata). In yet another embodiment, the system 100 can store multiple decluttered displays (e.g., store the captured image and associated POI information) for later retrieval and review.

As noted previously, the mapping display of the system 100 is not limited to augmented reality displays and may include other types of mapping displays such an augmented virtuality display (e.g., using 3D models to represent real world locations and POI information), conventional 3D maps, 2D maps, and/or another other display of mapping, location, or navigation information. In this way, the system 100 can declutter and organize the presentation of POIs or other map objects on the mapping display while maintaining a visual reference (e.g., via the captured image) to the viewpoint from which the POIs were selected. As used herein, in certain embodiments, mapping, location, and navigation information (collectively referred to herein as mapping information) refers to information about the user's location (e.g., map coordinates), other locations (e.g., destinations, POIs), relationships between locations (e.g., directions for traveling between the locations, relative positions of the locations, associations between the locations), and the like.

As shown in FIG. 1, a user equipment (UE) 101 may retrieve mapping information (e.g., POI information, 3D maps) from a map platform 103 via a communication network 105. The mapping information may be utilized by applications 107 on the UE 101 (e.g., an augmented reality application 107, a navigation application 107). The applications 107 may also include a decluttering manager 109 to declutter the mapping information in the mapping displays generated by the applications 107. Moreover, the mapping information may be included in a map database 111 associated with the map platform 103 for access by the applications 107. In certain embodiments, mapping information is information that may be utilized by the augmented reality application 107 to provide POI and related information to the user. As discussed previously, mapping information may also include maps, satellite images, street and path information, POI information, signing information associated with maps, objects and structures associated with the maps, information about people and the locations of people, coordinate information associated with the information, etc., or a combination thereof. A POI can be a specific point location that a person may, for instance, find interesting or useful. Examples of points-of-interest can include an airport, a bakery, a dam, a landmark, a restaurant, a hotel, the location of a person, or any point interesting, useful, or significant in some way.

In certain embodiments, mapping information (e.g., POI information) may be associated with content information including live media (e.g., streaming broadcasts), stored media (e.g., stored on a network or locally), metadata associated with media, text information, location information of other user devices, or a combination thereof. The content may be provided by the service platform 113 which includes one or more services 113a-113n (e.g., music service, mapping service, video service, social networking service, content broadcasting service, etc.), the one or more content providers 115a-115m (e.g., online content retailers, public databases, etc.), other content source available or accessible over the communication network 105. For example, the applications 107 may display location-related content information (e.g., content associated with a POI or with a particular location) in the mapping display in addition or as an alternate to the POI information. If there are high densities of such content information in the mapping display, the decluttering manager 109 may be used to organize and declutter the content information as well.

In one embodiment, an image capture module 117 of the UE 101 may be utilized in conjunction with the augmented reality application 107 to present location information (e.g., mapping and POI information) to the user. For example, the user may be presented with an augmented reality interface associated with the augmented reality application 107 or the navigation application 107 that presents mapping information (e.g., POI information), content information, and the like on a mapping display. In certain embodiments, the user interface may display a hybrid physical and virtual environment where 3D objects from the map database 111 are placed superimposed on top of a live (e.g., via a camera of the UE 101) or pre-recorded image (e.g., a 360° panoramic picture) of a corresponding location. In another embodiment, the mapping information and the maps presented to the user may be a simulated 3D environment in place of or in addition to the live augmented reality display. Accordingly, the decluttering manager 109 can operate on the augmented reality mapping display, the simulated 3D display, and/or other mapping displays to declutter mapping information (e.g., POI information, location-related content information) presented therein.

As noted, the UE 101 may execute one or more of the applications 107 to view or access mapping information. As mentioned above, the mapping information may include POI information, location information, directions or associations to a location, or a combination thereof. In one example, a default setting may allow the user to view information about POIs associated with locations, structures, and other objects associated with an augmented reality display or 3D environment. For example, the user may point the UE 101 towards a location or feature in the mapping display to view corresponding POI information. More specifically, the application 107 (e.g., the augmented reality application 107) may associate the location or feature with geographic coordinates based on the determined viewpoint. Then, the application 107 may retrieve POI information corresponding to the location from the map platform 103 for presentation in the mapping display. If the POI information includes multiple POIs that are closely located, the mapping display can become cluttered, making it difficult to discern and identify the closed located POIs. In this case, the decluttering manager 109 operates on the mapping display to reduce clutter by capturing an image of the mapping at the specified viewpoint (e.g., capturing an image currently visible in a viewfinder of the UE 101's camera) and displaying the POIs in a format that can render each POI distinctly (e.g., a scrollable list, non-overlapping icons, etc.). By associating the POI list with the captured image of the mapping display, the decluttering manager 109 advantageously maintains a visual reference between the actual location and the POIs visible at that location while reducing visual clutter.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, navigational device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, map platform 103, and service platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the augmented reality or navigation application 107 and the map platform 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

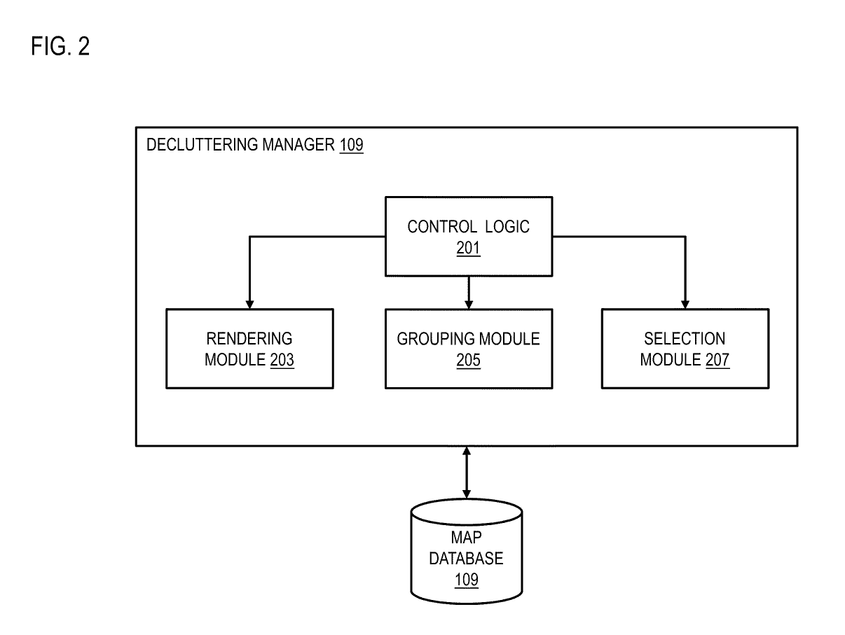

FIG. 2 is a diagram of the components of a decluttering manager, according to one embodiment. By way of example, the decluttering manager 109 includes one or more components for decluttering mapping information on a mapping display. It is contemplated that the functions of these components may be combined in one or more components or performed by other components of equivalent functionality. In this embodiment, the decluttering manager 109 includes at least a control logic 201 which executes at least one algorithm for executing functions of the decluttering manager 109. For example, the control logic 201 interacts with a rendering module 203 to render or display mapping information (e.g., POI information) on a mapping display of the UE 101. In one embodiment, the rendering module 203 presents an augmented reality display by directing the image capture module 117 of the UE 101 to provide to a user a live camera view of a current location of the UE 101. The image capture module 117 may include a camera, a video camera, and/or other imaging device. In one embodiment, visual media is captured in the form of an image or a series of images. These images are then presented in the mapping display by the rendering module 203.

In addition or alternatively to the augmented reality display, the rendering module 203 may provide a mapping display using non-reality based representations (e.g., a 3D simulated environment or other rendered maps) of a particular location as described above. For example, the rendering module 203 may obtain mapping data (e.g., 3D models, map tiles, map images, terrain features, etc.) from the map database 111 or the map platform 103 to render the mapping display.

After obtaining the underlying mapping display (e.g., either the augmented reality display or the rendered map), the rendering module 203 retrieves mapping information (e.g., POI and/or content information) to determine what POIs are visible in the display. The rendering module 203 then renders the visible POIs in the mapping display based, at least in part, on their location information. In other words, the rendering module renders the POIs so that the POIs are displayed in the mapping display at positions that correspond to their location information. As noted earlier, this rendering process, however, can result in a cluttered mapping display if there are multiple POIs that are closely located.

In certain embodiments, the rendering module 203 can interact with the grouping module 205 to group POIs that are closely located in the mapping display for rendering or display using one graphical element (e.g., a group icon) in the mapping display. In one embodiment, the group icons can be rendered in a way that distinguishes them from icons that represent single POIs. For example, group icons can use a different graphical design, be rendered in a different color, or be rendered in a different size.

Next, the control logic 201 directs the selection module to receive input from the UE 101 for selecting a group of the POIs. By way of example, this group may be a group created by the grouping module 205 as described above. In addition or alternatively, the group may be manually selected by the user from the mapping display. For example, the user tap on a set of overlapping or closely located POIs to select the entire group. In one embodiment, if the decluttering manager 109 is operating on an augmented reality display, the selection of a group of POIs causes the control logic 201 to direct the image capture module 117 to take a snapshot of the current camera viewfinder. In another embodiment where the mapping display is a rendered mapping display rather than a live view display, the selection can cause the rendering module to save a snapshot of the mapping display currently being displayed. In either case, the image is captured or saved with all POI information cleared from the image so that the image depicts only the underlying mapping display or recorded image of the surrounding location. In certain embodiments, the captured image can be associated with metadata indicating, for instance, the viewpoint or other characteristics of the UE 101, application 107, mapping display, or combination thereof at the time the image was captured.

Once the image is obtained, the control logic 201 directs the rendering module 203 to display the selected group of POIs as a list or in another non-overlapping format. The display of selected POIs is overlaid onto the captured image. In one embodiment, the captured image is used as the background image for the POI list display and can be dimmed or otherwise modified to improve the readability of the POI list. Additionally, each POI in the list can be rendered in a way to improve readability by, for instance, placing each POI in a text box, highlighting the POI, changing colors, applying animation or other effects, etc. More and then render the POIs in the mapping display based on the locations with respect to the locations displayed in the current mapping display. Moreover, if the number of POIs is greater than what can be distinctly rendered on a single screen of the mapping display, the rendering module 203 can present the POIs in a scrollable list. In addition or alternatively, the rendering module 203 can render the POIs in multiple screens of the mapping with each screen including the captured image as a background image.

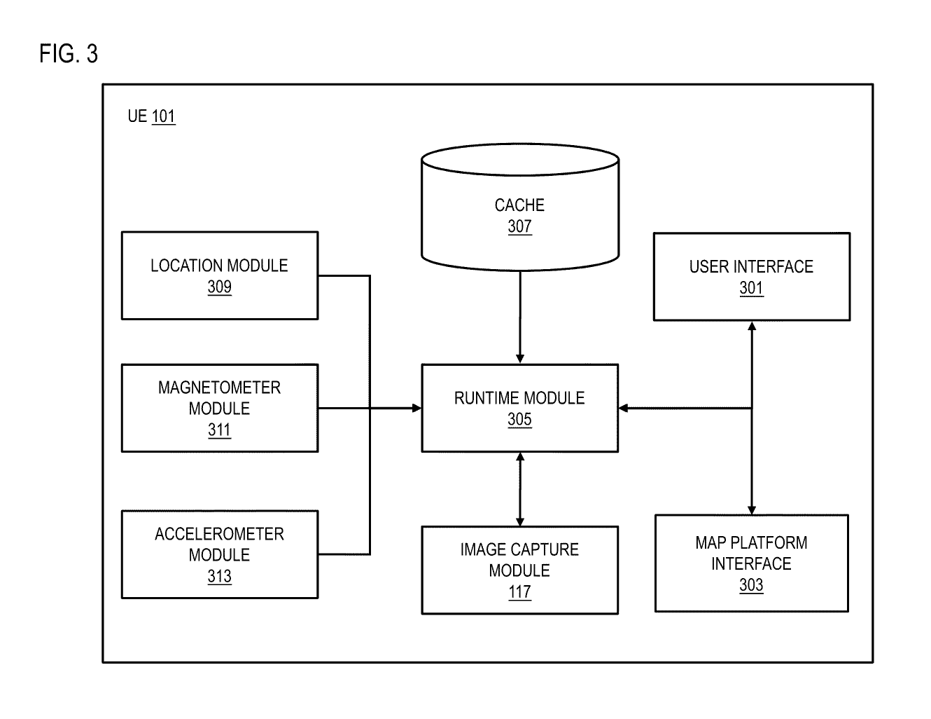

FIG. 3 is a diagram of the components of a user equipment capable of decluttering a mapping display, according to one embodiment. By way of example, the UE 101 includes one or more components for decluttering mapping information in a mapping display. It is contemplated that the functions of these components may be combined in one or more components or performed by other components of equivalent functionality. In this embodiment, the UE 101 includes: (1) a user interface 301 to present a mapping display including, for instance, POI information, and to receive input for selecting one or more POIs from the mapping display; (2) a map platform interface 303 to retrieve content and mapping information from the content mapping platform 103 and/or the service platform 113; (3) a runtime module 305 for executing one or more applications (e.g., augmented reality application 107, navigation application 107) that includes or has access to a decluttering manager 109; (4) a cache 307 to locally store mapping information and/or related content information; (5) a location module 309 to determine a location of the UE 101; (6) a magnetometer module 311 to determine horizontal orientation or directional heading (e.g., a compass heading) of the UE 101; and (7) an accelerometer module 313 to determine vertical orientation or an angle of elevation of the UE 101; and (8) an image capture module 117.

Both the cluttered and decluttered mapping display may be presented to the user via the user interface 301, which may include various methods of communication. For example, the user interface 301 can have outputs including a visual component (e.g., a screen), an audio component (e.g., a verbal instructions), a physical component (e.g., haptic feedback), and other methods of communication. User inputs can include a touch-screen interface, microphone, camera, a scroll-and-click interface, a button interface, etc. Further, the user may input a request to start an application 107 (e.g., an augmented reality or navigation application) and utilize the user interface 301 to receive a mapping display including POI and/or other mapping information. Through the user interface 301, the user may request different types of content, mapping, or location information to be presented. Further, the user may be presented with 3D or augmented reality representations of particular locations and related objects (e.g., buildings, terrain features, POIs, etc. at the particular location) as part of a graphical user interface on a screen of the UE 101.

The map platform interface 303 is used by the runtime module 305 to communicate with the map platform 103. In some embodiments, the interface is used to fetch content, mapping, and or location information from the map platform 103, service platform 113, and/or content providers 115a-115n. The UE 101 may utilize requests in a client server format to retrieve the mapping and content information. Moreover, the UE 101 may specify location information and/or orientation information in the request to retrieve the mapping and content information. The location module 309, magnetometer module 311, accelerometer module 313, and image capture module 117 may be utilized to determine location and/or orientation information used in determining along which direction the UE 101 is pointed (e.g., the viewpoint of the UE 101) so that mapping and content information corresponding to the pointed direction can be retrieved. Further, this mapping and content information may be stored in the cache 307 to be utilized in decluttering a mapping display at the UE 101.

In one embodiment, the location module 309 can determine a user's location. The user's location can be determined by a triangulation system such as a GPS, assisted GPS (A-GPS) A-GPS, Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 309 may also utilize multiple technologies to detect the location of the UE 101. GPS coordinates can provide finer detail as to the location of the UE 101. As previously noted, the location module 309 may be utilized to determine location coordinates for use by the application 107 and/or the map platform 103.

The magnetometer module 311 can include an instrument that can measure the strength and/or direction of a magnetic field. Using the same approach as a compass, the magnetometer is capable of determining the directional heading of a UE 101 using the magnetic field of the Earth. The front of the image capture device (e.g., a digital camera) (or another reference point on the UE 101) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is utilized to determine the orientation of the user. This directional information may be correlated with the location information of the UE 101 to determine where (e.g., at which geographic feature, object, or POI) the UE 101 is pointing towards. This information may be utilized to select a first person view to render mapping and content information in the mapping display.

Further, the accelerometer module 313 may include an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 313 can determine the angle the UE 101 is pointed as compared to Earth's gravity. In one embodiment, vertical directional data obtained from an accelerometer is used to determine the angle of elevation or tilt angle at which the UE 101 is pointing. This information in conjunction with the magnetometer information and location information may be utilized to determine a viewpoint to provide content and mapping information to the user. As such, this information may be utilized in selecting available content items to present navigational information to the user. Moreover, the combined information may be utilized to determine portions of a particular 3D map or augmented reality view that may interest the user. In one embodiment, if the location information associated with one or more available content items does not correspond to the viewpoint (e.g., is not visible in the selected viewpoint), one or more indicators (e.g., arrows or pointers) may be showed on the user interface to indicate the direction towards the location of the content items.

In another embodiment, the user may manually input any one or more of the location, directional heading, and tilt angle to specify a viewpoint for displaying the user interface on the UE 101 instead of determining the viewpoint from the sensors. In this way, the user may select a “virtual viewpoint” to be a place other than the current location and pointing direction of the UE 101.

Images for supporting a graphical user interface can be captured using the image capture module 117. The image capture module 117 may include a camera, a video camera, a combination thereof, etc. In one embodiment, visual media is captured in the form of an image or a series of images. The image capture module 117 can obtain the image from a camera and associate the image with location information, magnetometer information, accelerometer information, or a combination thereof. As previously noted, this combination of information may be utilized to determine the viewpoint of the user by combining the location of the user, horizontal orientation information of the user, and vertical orientation information of the user. This information may be utilized to retrieve mapping and content information from the map cache 307 or the map platform 103. In certain embodiments, the cache 307 includes all or a portion the information in the map database 111.

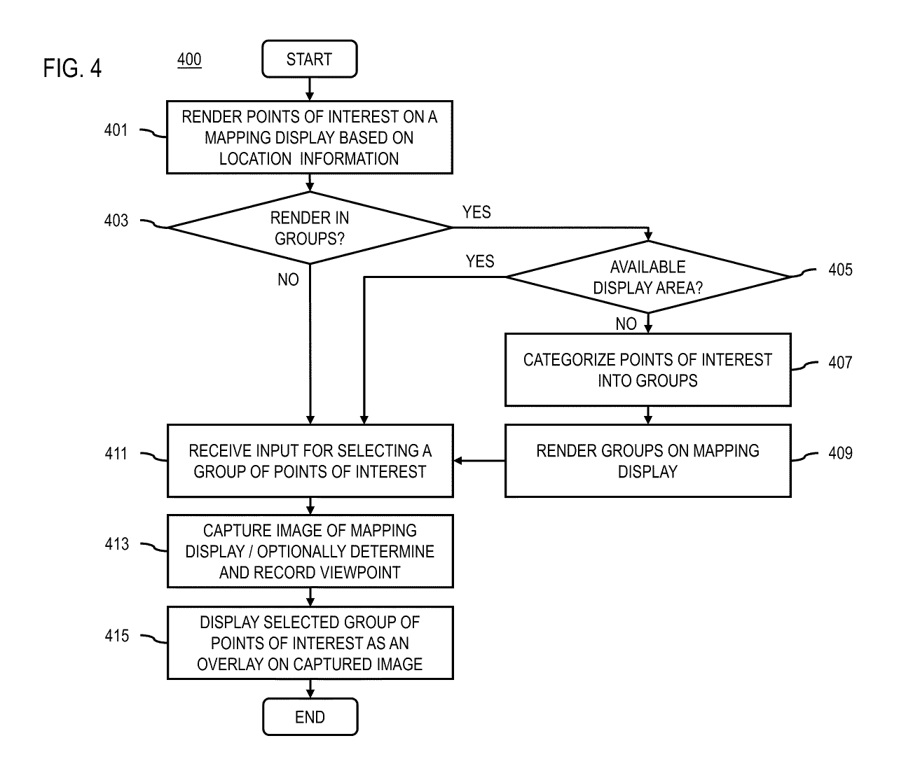

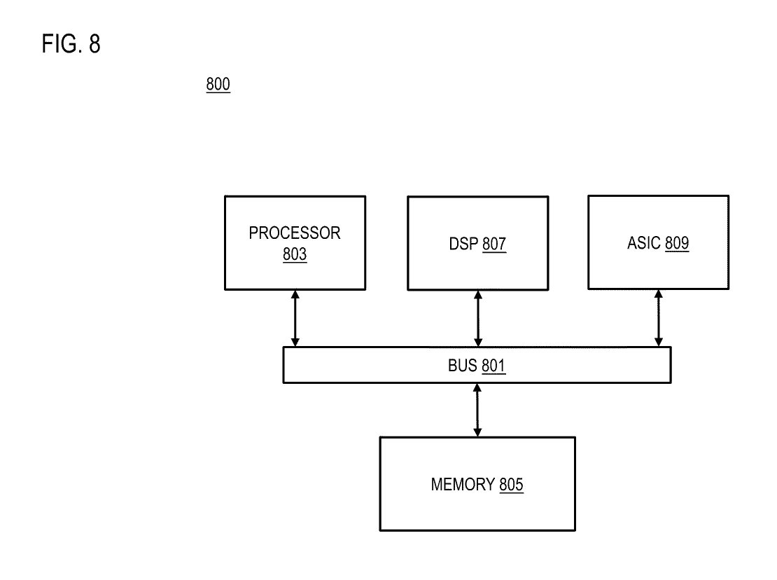

FIG. 4 is a flowchart of a process for decluttering a mapping display, according to one embodiment. In one embodiment, the runtime module 305 performs the process 400 and is implemented in, for instance, a chip set including a processor and a memory as shown FIG. 8. In certain embodiments, the map platform 103 may alternatively perform some or all of the steps of the process 400 and communicate with the UE 101 using a client server interface. The UE 101 may activate an augmented reality application 107 to utilize mapping services for presentation of mapping information. The augmented reality application 107 may execute upon the runtime module 305.

The runtime module 305 may utilize a location module 309, magnetometer module 311, accelerometer module 313, or a combination thereof to determine a viewpoint of the user as previously discussed. In other embodiments, the user may select the viewpoint based on a 3D environment. The user may select the viewpoint based on conventional means of searching a map or 3D map (e.g., by selecting a starting point and traversing the map or entering location coordinates, such as GPS coordinates or an address, of the viewpoint). From the selected viewpoint, the runtime module 305 can render a mapping display depicting a location including one or more POIs or other mapping information. More specifically, the POIs or mapping information are rendered in the mapping display based on the location information associated with each of the POIs. In other words, the POIs are rendered in the mapping display to reflect their actual locations in the geographical area depicted in the mapping display (step 401).

As previously noted, the mapping display may represent a physical environment, which may be captured using an image capture module 117 of the UE 101 to provide an augmented reality display. In another embodiment, the image may represent a virtual 3D environment, where the user's location in the real world physical environment is represented in the virtual 3D environment. In the representation, the viewpoint of the user is mapped onto the virtual 3D environment. Moreover, a hybrid physical and virtual 3D environment may additionally be utilized to present navigational information to the user. The augmented reality application 107 may determine what mapping information to present based on user preferences or other system parameters or settings (e.g., a default setting). In certain embodiments, the mapping information includes a type (or types) of POI (e.g., a coffee shop) that the user is searching for. In other embodiments, the mapping display may also include navigational information such as a directional indicator to a location that the user is searching for (e.g., a friend, a particular POI, etc.). The location can be determined by querying the map platform 103, which may include location information for POIs and additionally may be capable of tracking the movement of people using dynamic positioning technology (e.g., by detecting the presence of a user via GPS information). A person may utilize a device that shares the location of the person with the map platform 103 (e.g., a user tracking service, a location-aware social networking service, etc.). The shared location information may be included as a part of the mapping information rendered in the mapping display.

Next, the runtime module 305 determines whether to render the one or more of the POIs, mapping information, and/or content information that is to be presented in the mapping display as one or more groups (step 403). The runtime module 305 may make this determination based a predetermined configuration (e.g., a user profile) specified by the user, the service provider, the network operator, and/or the like. If mapping information is configured to be grouped, the runtime module determines whether there is available display area in the mapping display to distinctly render all of the mapping information without overlapping or obscuring any of the information (step 405). By way of example, the runtime module makes this determination by calculating the amount of display area (e.g., in pixels) needed to render the mapping information, and then compares the calculated need against the area in the mapping display that is available for displaying information.

If there is not enough display area, the runtime module 305 initiates the group process by categorizing the POIs or mapping information visible in the mapping display into one or more groups (step 407). In one embodiment, the runtime module 305 categorizes the POIs or mapping information based on their proximity to one another. For example, POIs or mapping information this are located near each other (e.g., within a predetermined distance) can be grouped. In other embodiments, it is contemplated that the runtime module 305 may use any criteria (e.g., POI type, descriptive metadata, etc.) to group the information. Once grouped, the runtime module 305 renders the grouped information (e.g., a group of POIs) in the mapping display in place of the individual POIs within the group (step 409).

Then, at step 411, the runtime module 305 receives input from the device for selecting one or more POIs or groups of POIs for decluttering (step 411). For example, the user can select a group of overlapping or obscured POIs or other mapping information to toggle the display of the selected POIs to a decluttered display. In addition or alternatively, the runtime module 305 can render all mapping information or POIs displayed in the original mapping display in decluttered form rather than just the selected information. In other words, the runtime module 305 can declutter all of the visible POIs in the display without needing the user to make a specific selection. After the mapping information is selected, the runtime module 305 causes, at least in part, capture of an image of the current mapping display (step 413). As discussed previously, capturing an image when the mapping display is an augmented reality displays includes taking a snapshot of the current view through the viewfinder of the camera. This view represents the geographic area or location associated with the mapping information. If the mapping view is a rendered mapping display (e.g., generated by the application 107 from mapping data), the runtime module 305 captures an image of the current mapping display using, for instance, a screen capture function. Optionally, the runtime module 305 may determine the viewpoint (e.g., location, directional heading, and tilt angle) of the UE 101 when the image of the current view or mapping display is capture. This determined viewpoint information is then associated with captured image (e.g., stored in the metadata of the captured image).

In step 415, the runtime module 305 displays the selected one or more POIs or mapping information as an overlay on the captured image in a format that distinctly renders each of the POIs. In one embodiment, the captured image can be dimmed or otherwise modified to make the selected POIs or mapping information more readable or prominent in the decluttered mapping display. As noted previously, using the captured image of the mapping display enables the runtime module 305 to quickly and easily reference the displayed POIs to the appropriate view of the geographic location associated with the POIs. For example, displaying the selected mapping information as a list without reference to the captured image makes it more difficult to identify the location or context with which the POIs are associated. Further, the captured image, in essence, locks the viewpoint to the view with the selected POIs so that the user need not point or maintain the UE 101 at a particular location, directional heading, and tilt angle. In this way, the user can more easily review the POIs or mapping information in the selected viewpoint. In addition, because the selected POIs or mapping information are rendered as an overlay that is distinct from the captured image, the runtime module 305 can separately render the two components so that the POI list can be manipulated (e.g., scrolled, selected, etc.) separately from the background image, thereby providing greater user experience flexibility.

In certain embodiments, each POI entry in the list can be independently selected. In this way, the user can select any POI in the list and then be linked to the location of the selected POI in the mapping display or to additional information related to the POI. In addition, the user may select multiple POIs in the list. For example, the runtime module 305 can enable multiple selections by highlighting each selected POI in the list (e.g., displaying a small icon next to a selected POI or otherwise distinguishing selected POIs from non-selected POIs). The runtime module 305 can then link to the locations or other information related to the selected POIs.

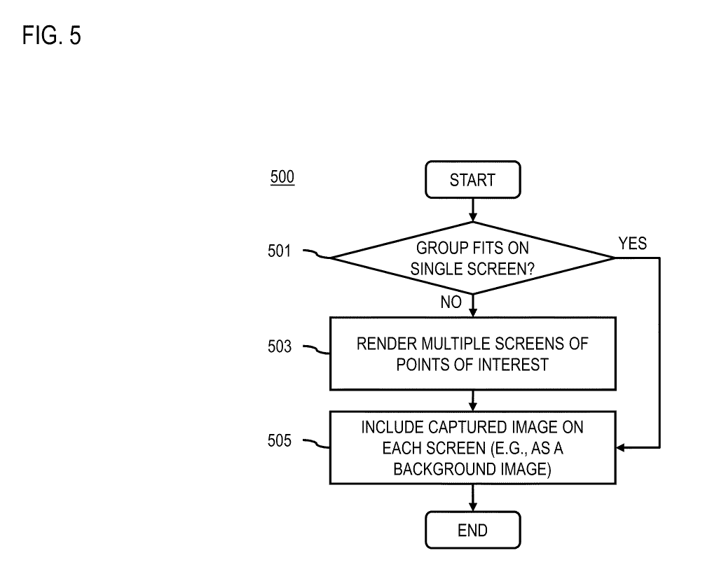

FIG. 5 is a flowchart of a process for rendering a decluttered mapping display on multiple screens, according to on embodiment. In one embodiment, the runtime module 305 performs the process 500 and is implemented in, for instance, a chip set including a processor and a memory as shown FIG. 8. In certain embodiments, the map platform 103 may alternatively perform some or all of the steps of the process 500 and communicate with the UE 101 using a client server interface. The process 500 assumes that the runtime module has already rendered an initial cluttered mapping display and received an input for selecting one or more groups of POIs or mapping information for decluttering as described with respect to the process 400 of FIG. 4.

In step 501, the runtime module 305 determines whether the POIs in the selected group can be distinctly rendered in one screen of the decluttered mapping display. As discussed previously, this determination can be made by, for instance, comparing a screen display area (e.g., in pixels) that is needed to display each POI according to a predetermined format. For example, the format may include text, graphics, and/or other user interface elements (e.g., arrows, bullets, indicators, etc.) that take a certain amount of display area. This display area is compared against the display area available in the decluttered display.

If all of the POIs in the selected group cannot fit on a single screen of the decluttered display, the runtime module can render multiple screens of the points of interest (step 503) and include the captured image of the corresponding location or viewpoint on each of the multiple screens (step 505). By way of example, the captured image is used a background image in the decluttered display. It is also contemplated that the captured image may be displayed as a thumbnail or in any other format of the decluttered mapping display so that the POIs can be associated with or referenced to the location indicated by the captured image. In addition or alternatively, the runtime module 305 can render the selected POIs in a scrollable list on a single screen of the decluttered mapping display. In either case, rendering either multiple screens or a scrollable list enables the runtime module 305 to advantageously distinctly list and declutter any number POIs in the mapping display.

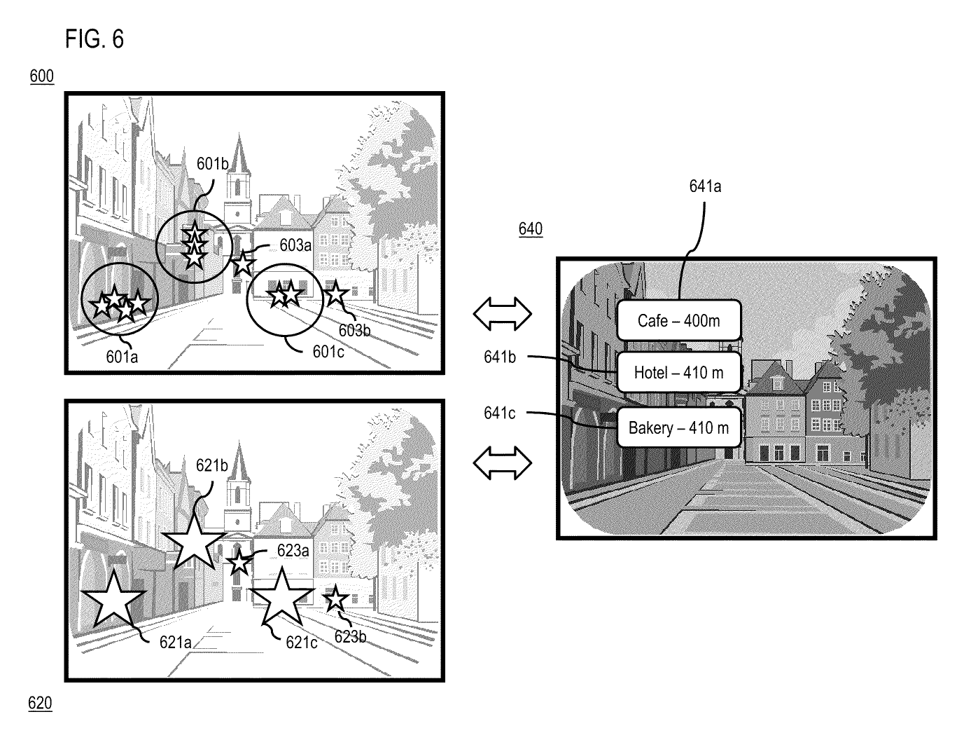

FIG. 6 is a diagram of user interfaces utilized in the process of FIG. 4, according to various embodiments. As shown, user interface 600 depicts an augmented reality mapping with star-shaped icons indicating POIs located within the viewpoint. These POIs are arranged in three clusters 601a-601c with cluster 601a containing four different POIs, cluster 601b containing three POIs, and cluster 601c containing two POIs. In addition, there are two individual POIs 603a and 603b. The clusters 601a-601c represent POIs that are located relatively close to each other so that their respective icons overlap, leading to cluttering of the display area and obscuring of the POIs. Because user interface 600 is an augmented reality display, the image displayed in the mapping is a live image of, for instance, a town square.

In one embodiment, the overlapping clusters 601a-601c can be grouped and represented by a common icon. User interface 620 depicts the same augmented reality display in which overlapping POIs have been grouped by proximity so that closely located POIs are shown using a single icon. In this example, the large star-shaped icons 621a-621c are grouped versions of the corresponding clusters 601a-601c. The single POIs 623a and 623b remain the same as their counterparts in user interface 600.

From either user interface 600 or 620, a user can select one or more POIs or groups of POIs (e.g., clusters 601a-601c or groups 621a-621c) to generate a decluttered user interface 640. In this example, the user interface 640 is generated when a user selects or taps on the cluster 601b of user interface 620 or the equivalent group 621b of user interface 640. On the selection, the system 100 initiates capture of the current view (e.g., the town square) and uses this captured image as the background for the decluttered display. At this point, the UE 101 that is displaying the user interface 640 can move the device to a new viewpoint without disturbing or changing the decluttered mapping displayed because the decluttered display is using the captured image of the town square instead of the live view. To further differentiate the live view from the decluttered view, the background image in user interface 640 is dimmed in comparison to the actual image.

The system 100 then displays the three POIs in the selected group of POIs (e.g., cluster 601b or group 621b) in a list presented in the user interface 640. Each decluttered POI listing 641a-641c distinctly renders and identifies the three POIs that were formerly obscured in both the user interfaces 600 and 620. For example, the listing 641a shows that the first POI is a cafe located 400 m from the viewer, the listing 641b shows that the second POI is a hotel located 410 m from the viewer, and the listing 641c shows that the third POI is a bakery located 410 m from the viewer. As shown, the decluttered user interface 640 enables the user to more easily view and identify the formerly obscured POIs. The use of the captured image of the viewpoint further enables the viewer to associate or reference the decluttered POIs with the location in the capture image.

The processes described herein for decluttering a mapping display may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

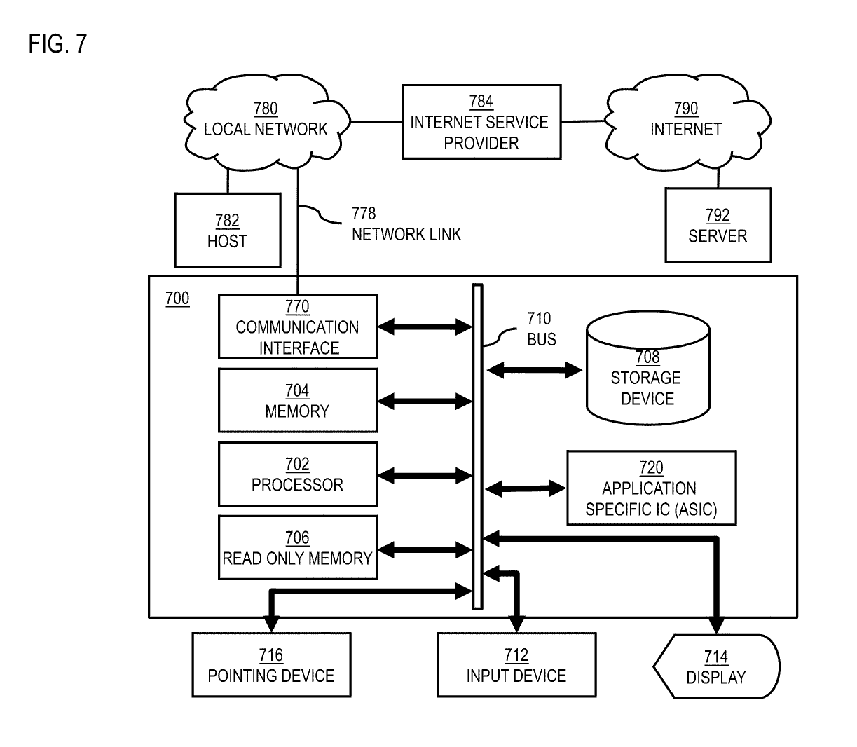

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to declutter a mapping display as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of decluttering a mapping display.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to declutter a mapping display. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for decluttering a mapping display. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for decluttering a mapping display, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for decluttering a mapping display.

The term “computer-readable medium” as used herein to refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to declutter a mapping display as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of decluttering a mapping display.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to declutter a mapping display. The memory 805 also stores the data associated with or generated by the execution of the inventive steps.

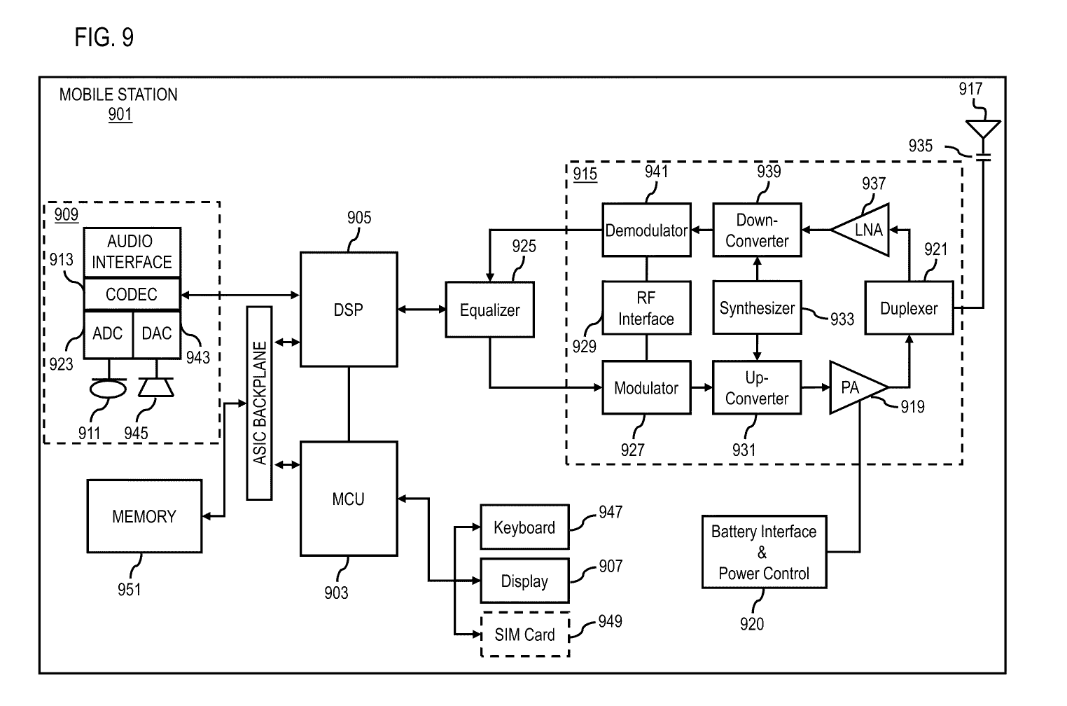

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of decluttering a mapping display. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of decluttering a mapping display. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to declutter a mapping display. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, rendering of a plurality of points of interest on a mapping display of a user device based on location information associated with each of the points of interest;
receiving an input, from the device, for selecting a group of the points of interest on the mapping display;
causing, at least in part, capture of an image of the mapping display based on the input; and
causing, at least in part, display of the selected group of the points of interest as an overlay on the captured image,
wherein the display of the selected group distinctly renders each of points of interest in the selected group.

2. A method of claim 1, wherein the mapping display is an augmented reality display and the captured image of the mapping display is snapshot of a current view in a camera viewfinder of the user device.

3. A method of claim 2, further comprising:
determining a location, a directional heading, a tilt angle, or a combination thereof of the user device when the image is captured; and
associating the determined location, directional heading, tilt angle, or combination thereof with the captured image.

4. A method of claim 1, wherein the selected group of points of interest is displayed as a list.

5. A method of claim 1, further comprising:
determining whether there is available display area in the mapping display to distinctly render the points of interest;
categorizing the points of interest into one or more groups based on the determination; and
causing, at least in part, rendering of the one or more categorized groups on the mapping display,
wherein the selecting of the group of the points of interest is from among the one or more categorized groups.

6. A method of claim 1, wherein the overlay relates each of the points of interests in the selected group to a respective location of the point of interest on the captured image.

7. A method of claim 1, further comprising:
determining whether the points of interest in the selected group can be displayed on a single screen of the mapping display; and
based on the determination, causing, at least in part, rendering of the points of interest in the selected group on multiple screens of the mapping display,
wherein each of the multiple screens includes the captured image.

8. A method of claim 1, wherein the captured image is dimmed with respect to the rendering of the one or more points of interest corresponding to the selected cluster.

9. An apparatus comprising:
at least one processor; and
at least one memory including computer program code,
the at least one memory and the computer program code configured to, with the at least one processor, cause the apparatus to perform at least the following,
cause, at least in part, rendering of a plurality of points of interest on a mapping display of a user device based on location information associated with each of the points of interest;
receive an input, from the device, for selecting a group of the points of interest on the mapping display;
cause, at least in part, capture of an image of the mapping display based on the input; and
cause, at least in part, display of the selected group of the points of interest as an overlay on the captured image,
wherein the display of the selected group distinctly renders each of points of interest in the selected group.

10. An apparatus of claim 9, wherein the mapping display is an augmented reality display and the captured image of the mapping display is snapshot of a current view in a camera viewfinder of the user device.

11. An apparatus of claim 10, wherein the apparatus is further caused to:
determine a location, a directional heading, a tilt angle, or a combination thereof of the user device when the image is captured; and
associate the determined location, directional heading, tilt angle, or combination thereof with the captured image.

12. An apparatus of claim 9, wherein the selected group of points of interest is displayed as a list.

13. An apparatus of claim 11, wherein the apparatus is further caused to:
determine whether there is available display area in the mapping display to distinctly render the points of interest;
categorize the points of interest into one or more groups based on the determination; and
cause, at least in part, rendering of the one or more categorized groups on the mapping display,
wherein the selecting of the group of the points of interest is from among the one or more categorized groups.

14. An apparatus of claim 9, wherein the overlay relates each of the points of interests in the selected group to a respective location of the point of interest on the captured image.

15. An apparatus of claim 9, wherein the apparatus is further caused to:
determine whether the points of interest in the selected group can be displayed on a single screen of the mapping display; and
based on the determination, cause, at least in part, rendering of the points of interest in the selected group on multiple screens of the mapping display,
wherein each of the multiple screens includes the captured image.

16. An apparatus of claim 9, wherein the captured image is dimmed with respect to the rendering of the one or more points of interest corresponding to the selected cluster.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
causing, at least in part, rendering of a plurality of points of interest on a mapping display of a user device based on location information associated with each of the points of interest;
receiving an input, from the device, for selecting a group of the points of interest on the mapping display;
causing, at least in part, capture of an image of the mapping display based on the input; and
causing, at least in part, display of the selected group of the points of interest as an overlay on the captured image,
wherein the display of the selected group distinctly renders each of points of interest in the selected group.

19. A computer readable storage medium of claim 18, wherein the mapping display is an augmented reality display and the captured image of the mapping display is snapshot of a current view in a camera viewfinder of the user device, and the selected group of points of interest is displayed as a list.

20. A computer readable storage medium of claim 19, wherein the apparatus is further caused to perform:
determining a location, a directional heading, a tilt angle, or a combination thereof of the user device when the image is captured; and
associating the determined location, directional heading, tilt angle, or combination thereof with the captured image.
